(19) United States
(12) Patent Application Publication
(10) Pub. No.: US 2012/0043366 A1
(43) Pub. Date: Feb. 23, 2012

(54) NAIL GUIDER AND NAILING DEVICE HAVING THE SAME

(76) Inventors: Jing-Li WANG, Taichung Hsien (TW); Rong-Yu Wang, Taichung Hsien (TW)

(21) Appl. No.: 13/213,661

(22) Filed: Aug. 19, 2011

(30) Foreign Application Priority Data
Aug. 20, 2010 (TW) 099127890

(51) Int. Cl. B25C 5/00

(52) U.S. Cl. 227/139

(57) ABSTRACT

The present invention provides a nail guider including a guiding board, at least an assisting member and a pushing means. The guiding board positioned in front of the nail track vertically has a first surface and a second surface. The first surface faces the nail track. The guiding board has at least a vertical penetrating slot thereon. The penetrating slot penetrates the first surface and the second surface of the guiding board. The assisting member, including an assisting end and a pushing end, slides forwardly and backwardly in the penetrating slot. The assisting end protrudes out of the first surface selectively, and the pushing end is located at the second surface. The assisting member used for straightening up nails further comprises at least an assisting surface parallel to the nailing track. The pushing means is used for pushing the pushing end elastically.

### BACKGROUND OF THE INVENTION

1. Field of the Invention

The present invention relates to the field of a nail guider and a nailing device having the same

2. Description of the Prior Art

Conventional nailing devices use a striking board for striking nails so that the nail could be nailed into a target. Among conventional nailing devices, some of them would be disposed with a nail guider in front of a nail track so that the nail would be hit out vertically or the nail would not stock the nail track because of being crooked. As such, the nail can keep standing vertically before being hit out with the help of the nail guider.

As the patent U.S. Pat. No. 5,692,665 mentioned, a nail guider is disclosed. In the FIG. 1 of the patent, the two guiding feet 8, 9 can use elasticity for pivoting to the front of the nail track selectively. Thus, the nail is straightened up. Besides, as shown in FIG. 3, the composition method of the two guiding feet 52, 62 is replaced by using a fulcrum 33. Also, the nail guider uses the elastic slice 70 for abutting and pushing the two guiding feet 52, 62 so that the two guiding feet 52, 62 would pivot toward a direction of the nail track.

In other words, the guiding feet of the conventional nail guiders is designed to pivot. The disadvantage of the design is that the guiding feet would be tilting when straightening the nail up. As a result, a lateral side of the nail could not be completely straightened up, and a force could not distribute on the nail evenly as well. Thus, the function of the nail guider would be influenced.

### SUMMARY OF THE INVENTION

The main object of the present invention is to provide a nail guider capable of straightening lateral sides of nails completely.

To achieve the above, the present invention provides a nail guider to be disposed in a nailing device, and the nailing device comprises a nail track. The nail guider is disposed in front of the nail track. The nail guider comprises a guiding board, at least an assisting member and a pushing means. The guiding board, positioned in front of the nail track vertically, has a first surface and a second surface, and the first surface is opposite to the second surface. The first surface faces the nail track, and the guiding board 10 has at least a vertical penetrating slot thereon.

The penetrating slot penetrates the first surface and the second surface of the guiding board. The assisting member can slide forwardly and backwardly in the penetrating slot, and the assisting member has an assisting end and a pushing end. The assisting end protrudes out of the first surface selectively, and the pushing end is located at the second surface. The assisting member further comprises at least an assisting surface parallel to the nailing track. In other words, the assisting surface is located at two sides of the assisting end, and the assisting surface is used for straightening up nails. As such, the assisting end has a tendency of protruding out of the first surface.

In conclusion, speaking of a former disadvantage that nail guiders with pivoting design disables nails to be supported with even force, so a feature that the assisting member can straightly slide along a horizontal direction improves the former disadvantage. Thus, the assisting member keeps straightening the nail up in a vertical moving process of the striking board, so the nails would not be crooked or stocked when being stroke by the striking board. The working efficiency of the nailing device is enhanced as well.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a decomposition drawing of the present invention;

FIG. 2 is a stereogram of the present invention;

FIG. 3 is a schematic drawing showing a first embodiment of the present invention;

FIG. 4 is a schematic drawing showing a second embodiment of the present invention;

FIG. 5 is a cross-sectional drawing showing an operating condition of the first embodiment of the present invention;

FIG. 6 is a cross-sectional drawing showing an operating condition of the second embodiment of the present invention;

FIG. 6A is a schematic drawing of a striking board of the present invention;

FIG. 7 is a schematic drawing of a nailing device of the present invention.

### DETAILED DESCRIPTION OF THE PREFERRED EMBODIMENTS

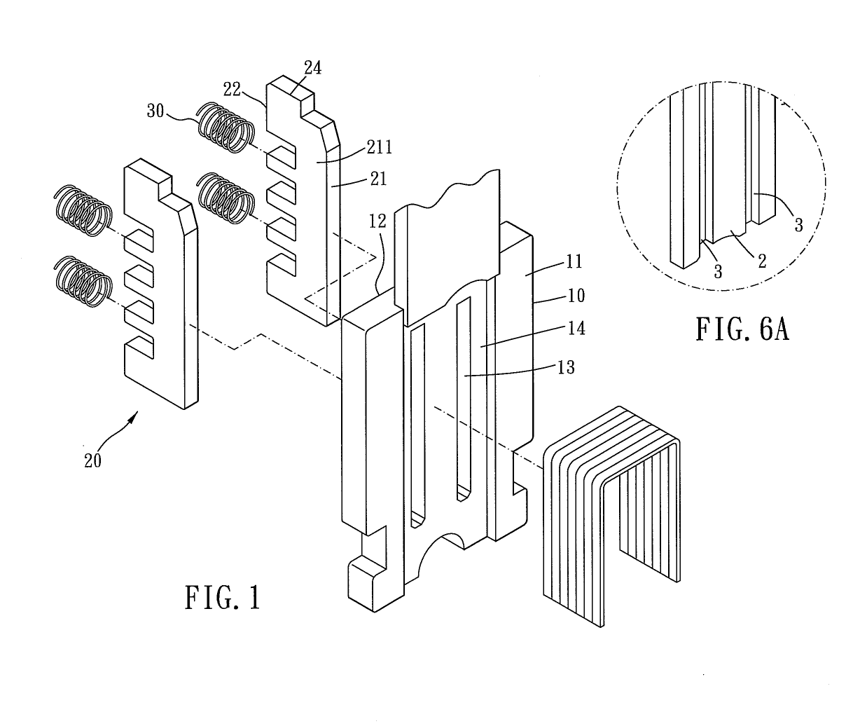

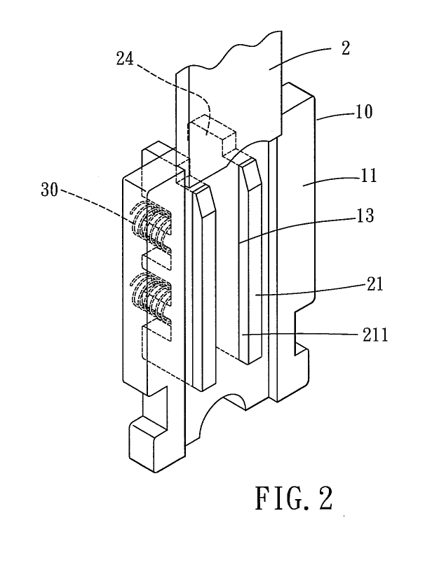

Please refer to FIG. 1 and FIG. 2, the nail guider is used for being disposed in a nailing device comprising a nail track, and the nail guider positioned in front of the nail track. The nail guider comprises a guiding board 10, at least an assisting member 20 and a pushing means.

The guiding board 10, positioned in front of the nail track vertically, has a first surface 11 and a second surface 12, and the first surface 11 is opposite to the second surface 12. The first surface 11 faces the nail track, and the guiding board 10 has at least a vertical penetrating slot 13 thereon. In a preferred embodiment of the present invention, the guiding board 10 has two vertical penetrating slots 13 thereon. The penetrating slot 13 penetrates the first surface 11 and the second surface 12 of the guiding board 10. To increase more perfection to the nail guider of the present invention, the first surface 11 of the guiding board 10 has a guiding slot 14 extending vertically, and the guiding slot 14 is used for guiding a striking board 2 or a nail sliding along the guiding slot 14 vertically.

The assisting member 20 corresponds to the penetrating slot 13, and the assisting member 20 is inserted in the penetrating slot 13. The assisting member 20 can slide forwardly and backwardly in the penetrating slot 13, and the assisting member 20 has an assisting end 21 and a pushing end 22. The assisting end 21 protrudes out of the first surface 11 selectively, and the pushing end 22 is located at the second surface 12. The assisting member 20 further comprises at least an assisting surface 211 parallel to the nailing track. In other words, the assisting surface 211 is located at two sides of the assisting end 21, and the assisting surface 211 is used for straightening up nails.

The pushing means is used for pushing the pushing end 22 elastically, so the assisting end has a tendency of protruding out of the first surface 11. In the preferred embodiment of the present invention, the pushing means comprises at least one pair of springs 30 corresponding to the assisting member 20, and the pair of the springs 30 is horizontally positioned and vertically arranged to push the assisting member 20. As such, a forcing power is evenly distributed to the assisting member 20 so that the assisting member 20 can move in a horizontal direction smoothly. In the preferred embodiment of the present invention, the pushing end 22 is in a structure of battlements with plural convex blocks and concave slots. Each of the springs 30 is disposed around one of the convex blocks. Moreover, the assisting member 20 can further comprise a stopping portion 24 to prevent the assisting member 20 from sliding out of the penetrating slot 13 completely. The stopping portion 24 is close to the second surface 12, and a position of the stopping portion 24 is over a contour of the penetrating slot 13. The stopping portion 24 abuts against the guiding board 10 to reach an effect of limiting a position of the assisting member 21, making the assisting member 21 protrude out of the first surface 11 correctly and preventing the assisting member 21 from completely sliding out of the penetrating slot 13 when the assisting end 21 protrudes out of the first surface 11.

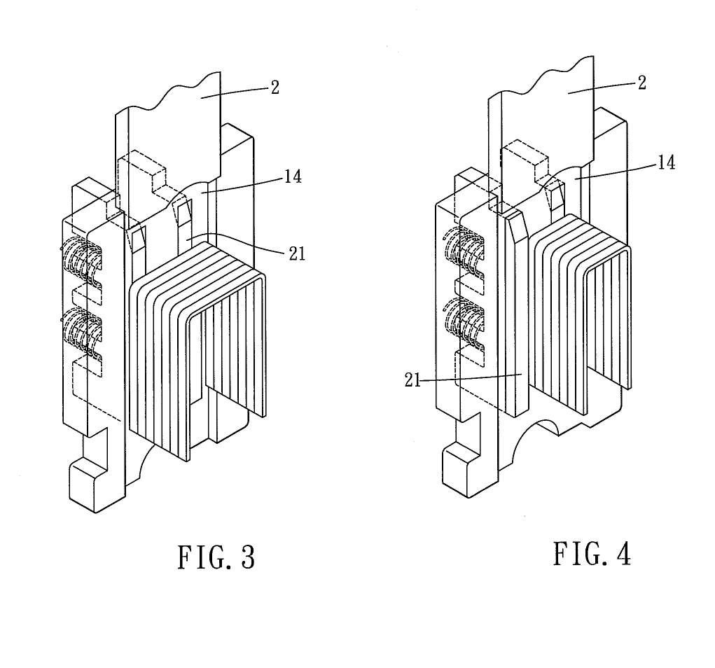

As shown in FIG. 3 and FIG. 4, the nail guider of the present invention can be adapted to be used with nails of various sizes. For instance, in FIG. 3, because the breadth of the nail is wider, the two assisting member 20 can be pushed toward a direction away from the nail track with being straightened up by lateral sides of the guiding slot 14. However, in the FIG. 4, because the breadth of the nail is narrower, one of the two assisting member 20 can offer the assisting surface 211 for the nail to abut. As such, the nail can still be straightened up. Surely, in other possible embodiments of the present invention, the nail guider can be adapted to be used with nails of various types such as U-shaped nails and I-shaped nails.

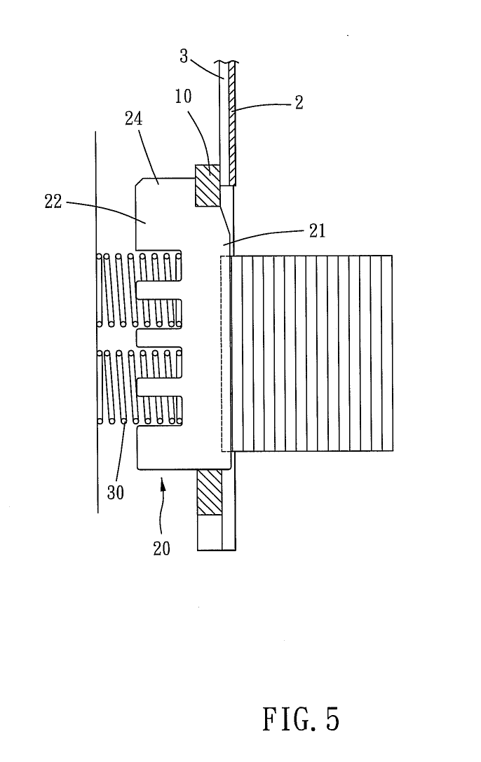

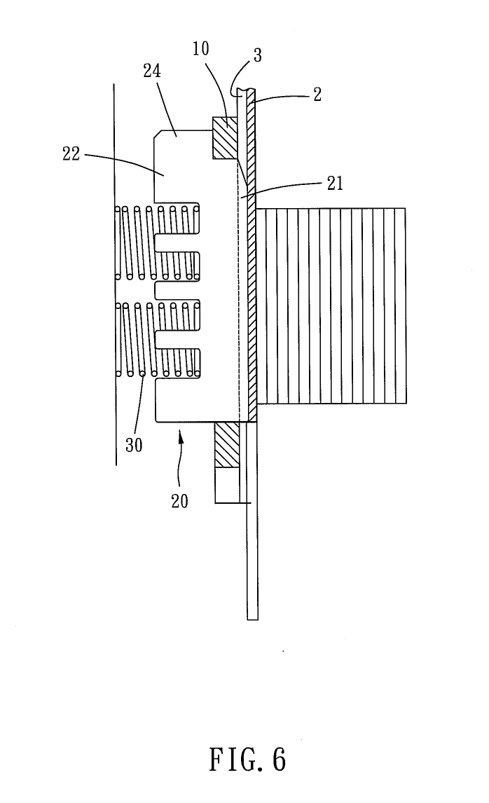

Please refer to FIG. 5, the assisting member 20 can abut against a lateral side of the nail to straighten the nail up when the nail is ready to be strike out. And as shown in FIG. 6, the striking board 2 moves downwardly when a striking operation is started up. As shown in FIG. 6A, the striking board 2 has an inner side facing the first surface 11 of the guiding board 10, and the inner side has at least one slot 3 corresponding to the assisting member 20. When the assisting end 21 protrudes out of the first surface 11, the assisting end 21 is located in the slot 3. Because the assisting member 20 can keep straightening the nail up in an up-and-down moving process of the striking board 2, the assisting member 20 can lead the nail to be stroke out vertically. And the striking operation is finished.

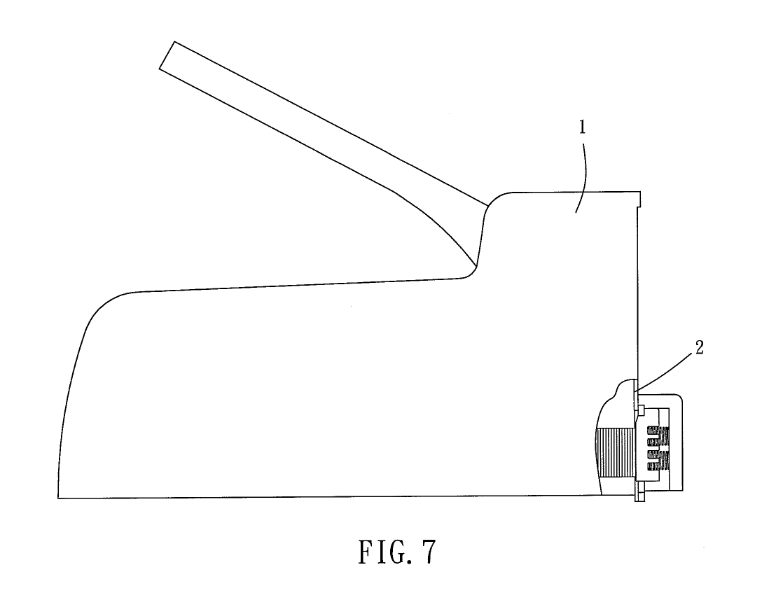

Furthermore, as shown in FIG. 7, the nailing device of the present invention includes the nail guider described above, the nail track, the striking board 2 and a shell 1. The shell 1 is used for containing the components mention above therein. The nail track is used for straightening nails up and driving the nails slide along an extending direction of the nail track. The striking board 2 strikes the nails out selectively.

The nail guider of the present invention enables the assisting member to evenly support on lateral sides of the nails by a feature that the assisting member can straightly slide along a horizontal direction. Thus, speaking of a former disadvantage that the nail guider with pivoting design disables the nail to be supported with even force, the nail guider of the present invention improves the former disadvantage. Moreover, the striking board has slots for containing the assisting end, so the assisting member can keep straightening the nail up in a vertical moving process of the striking board. Therefore, the nails would not be crooked or stocked when being stroke by the striking board.

What is claimed is:

1. A nail guider, used for being disposed in a nailing device with a nail track and positioned in front of the nail track, the nail guider comprising:
a guiding board, positioned in front of the nail track vertically, having a first surface and a second surface, the first surface being opposite to the second surface, the first surface facing the nail track, the guiding board having at least a vertical penetrating slot thereon, the penetrating slot penetrating the first surface and the second surface of the guiding board;
at least an assisting member, the assisting member corresponding to the penetrating slot, the assisting member being inserted in the penetrating slot, the assisting member can slide forwardly and backwardly in the penetrating slot, the assisting member having an assisting end and a pushing end, the assisting end protruding out of the first surface selectively, the pushing end being located at the second surface, the assisting member further comprising at least an assisting surface, the assisting surface being parallel to the nailing track, the assisting surface being used for straightening up nails; and
a pushing means, used for pushing the pushing end elastically, the assisting end having a tendency of protruding out of the first surface.

2. The nail guider of claim 1, wherein the pushing means comprises at least one pair of springs corresponding to the assisting member, the pair of the springs is horizontally positioned and vertically arranged to push the assisting member.

3. The nail guider of claim 1, wherein the assisting member further comprises a stopping portion, the stopping portion is close to the second surface, a position of the stopping portion is over a contour of the penetrating slot, the stopping portion abuts against the guiding board to reach an effect of limiting a position of the assisting member, making the assisting member protrude out of the first surface correctly and preventing the assisting member from completely sliding out of the penetrating slot when the assisting end protrudes out from the first surface.

4. The nail guider of claim 1, wherein the first surface of the guiding board has a guiding slot extending vertically, the guiding slot is used for guiding a striking board or a nail sliding vertically along the guiding slot.

5. A nailing device, comprising the nail guider of claim 1, the nail track, a striking board and a shell, wherein the nail guider, the nail track, and the striking board is disposed in the shell, the nail track has an extending direction, the nail track is used for supporting the nail to lead the nail moving along the extending direction, the striking board is used for striking the nail out selectively.

6. The nailing device of claim 5, wherein the striking board can move upwardly and downwardly along the first surface of the guiding board, the striking board has an inner surface facing the first surface of the guiding board, the inner surface has at least a sinking slot corresponding to the assisting member, the assisting end is located in the sinking slot when the assisting end protrudes out of the first surface.

7. The nailing device of claim 5, wherein the pushing means comprises at least one pair of springs corresponding to the assisting member, the pair of the springs is horizontally positioned and vertically arranged to push the assisting member.

8. The nailing device of claim 5, wherein the assisting member further comprises a stopping portion, the stopping portion is close to the second surface, the stopping portion is over a contour of the penetrating slot, the stopping portion abuts against the guiding board to reach an effect of limiting a position of the assisting member, making the assisting member protrude out of the first surface correctly and preventing the assisting member from completely sliding out of the penetrating slot when the assisting end protrudes out from the first surface.

9. The nailing device of claim 5, wherein the first surface of the guiding board has a guiding slot extending vertically, the guiding slot is used for guiding a striking board sliding vertically along the guiding slot.
